(19) United States
(12) Patent Application Publication
(10) Pub. No.: US 2023/0262512 A1
(43) Pub. Date: Aug. 17, 2023

(54) METHODS AND APPARATUSES FOR PROVIDING COMMUNICATION BETWEEN A REMOTE DEVICE AND A DESTINATION NODE VIA A RELAY DEVICE

(71) Applicant: Telefonaktiebolaget LM Ericsson (publ), Stockholm (SE)

(72) Inventors: Zhang Zhang, Beijing (CN); Min Wang, Luleå (SE); Antonino Orsino, Kirkkonummi (FI)

(21) Appl. No.: 18/026,455

(22) PCT Filed: Aug. 27, 2021
(86) PCT No.: PCT/CN2021/114895

§ 371 Date: Mar. 15, 2023

(51) Int. Cl. H04W 28/02; H04W 40/22

(52) U.S. Cl. CPC H04W 28/0268; H04W 40/22

(57) ABSTRACT

Embodiments described herein relate to methods and apparatuses for providing communication between a remote device and a destination node over a relay path comprising at least one relay device. A method comprises obtaining an indication that a quality of service, QoS, metric is not meeting a QoS requirement, wherein the QoS metric is associated with one of: a traffic flow between the remote device and the destination node, a radio bearer used in communication between the remote device and the destination node; and a logical channel used in communication between the remote device and the destination node; and responsive to the indication, initiating a recovery action to improve a QoS of the communication between the remote device and the destination node.

### TECHNICAL FIELD

Embodiments of the disclosure generally relate to wireless communication, and, more particularly, to methods and apparatuses for providing communication between a remote device and a destination node via a relay device.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

### NR Frame Structure

Similarly to Long Term Evolution (LTE), New Radio (NR) uses OFDM (Orthogonal Frequency Division Multiplexing) in the downlink (i.e. from a network node, gNB, eNB, or base station, to a user equipment (UE) or wireless device). The basic NR physical resource over an antenna port may thus be seen as a time-frequency grid as illustrated in FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource block corresponds to one OFDM subcarrier during one OFDM symbol interval.

Different subcarrier spacing values are supported in NR. The supported subcarrier spacing values (also referred to as different numerologies) are given by Δf=(15×2\hat{ }μ) kHz where μ ε (0,1,2,3,4). Δf=15 kHz is the basic (or reference) subcarrier spacing that is also used in LTE.

In the time domain, downlink and uplink transmissions in NR may be organized into equally-sized subframes of 1 ms each, similar to LTE. A subframe may be further divided into multiple slots of equal duration. The slot length for subcarrier spacing Δf=(15×2\hat{ } μ) kHz may be 1/2\hat{ } μms. There may be only one slot per subframe for Δf=15 kHz and a slot may consist of 14 OFDM symbols.

Downlink transmissions in NR may be dynamically scheduled, i.e., in each slot the gNB (or base station) may transmit downlink control information (DCI) about which UE data is to be transmitted to and which resource blocks in the current downlink slot the data is transmitted on. This control information is typically transmitted in the first one or two OFDM symbols in each slot in NR. The control information may be carried on the Physical Control Channel (PDCCH) and data may be carried on the Physical Downlink Shared Channel (PDSCH). A UE may first detect and decode PDCCH and if a PDCCH is decoded successfully, it may then decode the corresponding PDSCH based on the downlink assignment provided by decoded control information in the PDCCH.

In addition to PDCCH and PDSCH, there are also other logical channels and reference signals transmitted in the downlink, including Synchronization Signal Block (SSB), Channel State Information—Reference Signal (CSI-RS), etc.

Uplink data transmissions, carried on Physical Uplink Shared Channel (PUSCH), may also be dynamically scheduled by the gNB by transmitting Downlink Control Information(DCI)., the DCI (which is transmitted in the DL region) may indicate a scheduling time offset so that the PUSCH is transmitted in a slot in the UL region.

### Sidelink Transmissions in NR

Sidelink transmissions over NR are specified for Rel. 16. These are enhancements of the ProSe (PROximity-based SErvices) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver device to reply the decoding status to a transmitter UE.
Grant-free transmissions, which are adopted in NR uplink transmissions, are also provided in NR sidelink transmissions, to improve the latency performance.
To alleviate resource collisions among different sidelink transmissions launched by different wireless devices, Rel-16 enhances channel sensing and resource selection procedures, which also lead to a new design of PSCCH.
To achieve a high connection density, congestion control and thus the QoS management is supported in NR sidelink transmissions. To enable the above enhancements, new physical channels and reference signals are introduced in NR (available in LTE before):
PSSCH (Physical Sidelink Shared Channel, SL version of PDSCH): The PSSCH may be transmitted by a sidelink transmitter UE, which conveys sidelink transmission data, system information blocks (SIBs) for radio resource control (RRC) configuration, and a part of the sidelink control information (SCI).
PSFCH (Physical Sidelink, SL version of PUCCH): The PSFCH may be transmitted by a sidelink receiver UE for unicast and groupcast, which conveys 1 bit information over 1 RB for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE should first send the PSCCH, which conveys a part of SCI (Sidelink Control information, SL version of DCI) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS):

Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of process of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB should be transmitted within the bandwidth of the configured BWP. The PSBCH conveys information related to synchronization, such as the direct frame number (DFN), indication of the slot and symbol level time resources for sidelink transmissions, in-coverage indicator, etc. The SSB is transmitted periodically at every 160 ms.
DMRS, phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature introduced in Rel-16 is the two-stage sidelink control information (SCI). This may be considered a version of the DCI for SL. Unlike the DCI, only part (first stage) of the SCI is sent on the PSCCH. This part is used for channel sensing purposes (including the reserved time-frequency resources for transmissions, demodulation reference signal (DMRS) pattern and antenna port, etc.) and may be read by all wireless devices while the remaining (second stage) scheduling and control information such as a 8-bits source identity (ID) and a 16-bits destination ID, NDI, RV and HARQ process ID is sent on the PSSCH to be decoded by the receiver UE.

Similar as for PRoSE in LTE, NR sidelink transmissions may have the following two modes of resource allocations:

Mode 1: Sidelink resources are scheduled by a gNB (or base station).

Mode 2: The UE autonomously selects sidelink resources from a (pre-)configured sidelink resource pool(s) based on the channel sensing mechanism.

For the in-coverage wireless device, a gNB can be configured to adopt Mode 1 or Mode 2. For the out-of-coverage wireless device, only Mode 2 can be adopted.

As in LTE, scheduling over the sidelink in NR is done in different ways for Mode 1 and Mode 2.

Mode 1 supports the following two kinds of grants.

Dynamic grant: When the traffic to be sent over sidelink arrives at a transmitter UE, this transmitter UE may launch the four-message exchange procedure to request sidelink resources from a gNB (SR on UL, grant, BSR on UL, grant for data on SL sent to the transmitter UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the downlink control information (DCI) conveyed by PDCCH with CRC scrambled with the SL-RNTI. When a transmitter UE receives such a DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single TB. As a result, this kind of grant is suitable for traffic with a loose latency requirement.

Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE cannot receive the DCI (since it is addressed to the transmitter UE), and therefore a receiver UE should perform blind decoding to identify the presence of PSCCH and find the resources for the PSSCH through the SCI.

When a transmitter UE launches the PSCCH, a Cyclic Redundancy Check (CRC) may also be inserted in the SCI without any scrambling.

In the Mode 2 resource allocation, when traffic arrives at a transmitter UE, this transmitter UE may autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful Transport Block (TB) decoding and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE may select resources for the following transmissions:

1) The PSSCH associated with the PSCCH for initial transmission and blind retransmissions.

2) The PSSCH associated with the PSCCH for retransmissions.

Since each transmitter UE in sidelink transmissions may therefore be configured to autonomously select resources for above transmissions, how to prevent different transmitter UEs from selecting the same resources may be considered a critical issue when operating in Mode 2. A particular resource selection procedure may therefore be imposed when operating in Mode 2 based on channel sensing. The channel sensing algorithm for example involves measuring RSRP on different subchannels and may require knowledge of the different UEs power levels of DMRS on the PSSCH or the DMRS on the PSCCH depending on the configuration. This information may only be known after receiver SCI launched by (all) other UEs.

### Discovery Procedures

There are D2D discovery procedures for detection of services and applications offered by other UEs in close proximity. This is part of LTE Rel 12 and Rel 13. The discovery procedure has two modes, mode A based on open announcements (broadcasts) and mode B, which is request/response. The discovery mechanism is controlled by the application layer (ProSe). The discovery message is sent on the Physical Sidelink Discovery Channel (PSDCH) which is not available in NR. Also, there is a specific resource pool for announcement and monitoring of discovery messages. The discovery procedure can be used to detect UEs supporting certain services or applications before initiating direct communication.

### NR Re1.17 Work on Sidelink

In 3GPP Rel. 17, discussions are taking place and National Security and Public Safety (NSPS) is considered to be one important use case, which can benefit from the already developed NR sidelink features in Rel 16. Therefore, it is most likely that 3GPP will specify enhancements related to NSPS use case taking NR Rel. 16 sidelink as a baseline. Besides, in some scenarios, NSPS services may need to operate with partial NW coverage or without NW coverage, such as indoor firefighting, forest firefighting, earthquake rescue, sea rescue, etc. where the infrastructure may be (partially) destroyed or not available, therefore, coverage extension is a crucial enabler for NSPS, for both NSPS services communicated between UE and cellular NW and that communicated between UEs over sidelink There may be further exploration for a coverage extension for sidelink-based communication, including both UE to NW relay for cellular coverage extension and UE to UE relay for sidelink coverage extension. L1/L2 ID

Sidelink transmissions may be associated with a source Layer1/Layer2 (L1/L2) ID and a destination L1/L2 ID.

For example, for sidelink unicast, a source L1/L2 ID represents the service type and/or transmitter UE ID, which will become the destination L1/L2 ID of the peer UE. A sidelink unicast link is identified by the combination of source L1/L2 ID and destination L1/L2 ID.

For example, for sidelink groupcast, source L1/L2 ID represents the transmitter UE ID, and destination L1/L2 ID represents the group identifier provided by the upper layer or the service type.

For example, for sidelink broadcast, source L1/L2 ID represents the transmitter UE ID, and destination L1/L2 ID represents the service type.

In some examples, a connected UE will report the destination L2 ID to its serving cell/node.

### ProSe Direct Discovery

As described in clause 6.1 of TR 23.752, the discovery procedure which is being studied for NR Rel-17 is based on 5GC architecture, including authorization and provision, announcing and monitoring procedures, and protocol for discovery as detailed in clause 6.1.2 of TR 23.752.

In Evolved Packet System (EPS), there are two types of ProSe Direct Discovery: open and restricted. Open discovery is the case where there is no explicit permission that is needed from the UE being discovered, whereas restricted discovery only takes place with explicit permission from the UE that is being discovered. In some embodiments described herein, the restricted type is proposed.

Besides, there are two models for ProSe Direct Discovery exists in EPS: Model A and Model B. These two models are re-proposed in embodiments described herein as comprising the same mechanism in EPS. And the definition for Model A and Model B is as defined in clause 5.3.1.2 of TS 23.303.

For the direct discovery authorization and provision to the UE, it is expected the application function (AF) can provide the groups and/or service information to the PCF via NEF and the PCF provides the authorization to the UE according to the received information from the AF. The authorization and provision procedures in clauses 6.2.2 and 6.2.5 of TS 23.287 are reused to provide at least the following configurations:

1) The AF request sent to the Policy Control Function (PCF) (or via the Network Exposure Function (NEF)) may comprise the information as below:
The service information to be directly discovered over PC5 interface. The service information may comprise, e.g. Application identifier;
The group information (e.g. the external group identifier) to be directly discovered over PC5 interface;
The information may per announcing and monitoring direction for Model A or per discoverer UE and discoveree UE for Model B;
The area information, e.g. geographical information (longitude/latitude, zip code, etc).

(It may be for further study whether and how to configure the metadata information to the UE and what is the size of meta data that can be efficiently sent as part of discovery over PC5).

2) The provision to the UE from PCF, may comprise the following information based on the information received from the AF and local policy:
The service information to be directly discovered over PC5 interface. The service information may comprise, e.g. Application identifier;
The group information (e.g. the external group identifier) to be directly discovered over PC5 interface;
The area information used for direct discovery over PC5 interface; The area information could be geographical TA list. It is expected PCF will map the area information provided by AF to a list of TAs.
Security parameters used for direct discovery over PC5.

Uu RAT restriction may not be applied to PC5 operations for the UE. Uu RAT information may not need to be provisioned in the UE, e.g. to authorize the UE to send or monitor direct discovery message only when the UE camps on NR.

If the Access and Mobility Management Function (AMF) determines the UE is authorised to use direct discovery based on the authorised area information, the AMF may provide the UE is authorized to use direct discovery over PC5 interface to corresponding NG-RAN during N2 establishment for the UE. FIG. 2 illustrates an example Procedure for discovery procedure as described in in TS 23.752

In step 0 the user may obtain ProSe application user ID and ProSe application code for ProSe direct discovery using application layer mechanisms. The application layer in the UE may provide an application user ID and the application identifier to the ProSe Application Function. The ProSe Application Function may allocate a ProSe application user ID and ProSe application code to the application layer in the UE.

Step 0 may only needed for the applications for which there is privacy issue.

In step 1 the UE obtains the authorization and provision for announcing discovery and/or for monitoring/solicitation discovery as defined in clauses 6.2.2 and 6.2.5 of TS 23.287.

In step 2a when the announcing UE is triggered e.g. by an upper layer application to announce availability for interested groups and/or for interested applications, if the UE is authorised to perform the announcing UE procedure for the interested groups and/or the interested applications in step 1, then the UE may generate a PC5 direct discovery message for announcement and may include the following information in this message.
1) ProSe UE ID e.g. ProSe application user ID, Layer 2 ID.
2) The group ID(s) provided by the application layer.
3) The application ID(s) or ProSe application code(s) provided the application layer.

The announcing UE computes a security protection element (e.g. for integrity protection) and appends it to the PC5 message:

When the monitoring UE is triggered e.g. by an upper layer application or by the user to monitor proximity of other UEs for the interested group(s) and/or interested applications, and if the UE is authorised to perform the monitoring procedure for the group(s) and/or applications, then the UE monitors the discovery message. The monitoring UE verifies the security protection element using the provisioned security parameters corresponding to the application. If the verification of the security protection element succeeds, the service is successfully discovered by the monitoring UE. The monitoring UE may then notify the application layer using the result of the discovery.

In step 2b when the discoverer UE is triggered e.g. by an upper layer application or by the user to discover other UEs for the interested group(s) and/or interested applications, and if the UE is authorised to perform the discovery solicitation procedure for the group(s) and/or applications in step 1, then the UE mat send a solicitation message with the information of discoverer ProSe UE ID, application ID(s) or ProSe application code(s), group ID(s). The discoverer UE may compute a security protection element (e.g. for integrity protection) and appends it to the PC5 message.

If the discoveree UE is able to and authorised to respond to the discovery solicitation according to the received information in the solicitation message, then it may respond to the discovery message with the discoveree ProSe UE ID, the supported application ID(s) or ProSe application code(s) and group ID(s).

In step 3a if the monitoring UE/discoverer UE wants to request metadata corresponding to the discovered service in step 2, the monitoring UE/discoverer UE may send a unicast metadata request message to request discovery metadata. The monitoring UE/discoverer UE may use the Layer 2 ID of announcing UE/discoveree UE (received in step 2a or 2b) to send the Metadata Request message.

In step 3b the announcing UE/discoveree UE responds with the Metadata Response message. The announcing UE/discoveree UE includes the metadata information in the Metadata Response message.

### Relay UE (Re)Selection

In LTE a coverage based relay UE (re)selection is introduced, a remote UE performs relay UE (re)selection only when the measured Uu channel quality and/or SL channel quality to the current linked relay UE becomes bad, e.g. the measured channel quality becomes below than a configured threshold. The following illustrates an example detailed procedure for relay UE (re)selection as defined in clause 5.10.11.4 in TS 36.331:

A UE capable of sidelink remote UE operation that is configured by upper layers to search for a sidelink relay UE shall:
1> if out of coverage on the frequency used for sidelink communication, as defined in TS 36.304, clause 11.4; or
1> if the serving frequency is used for sidelink communication and the RSRP measurement of the cell on which the UE camps (RRC_IDLE)/the PCell (RRC_CONNECTED) is below threshHigh within remoteUE-Config:
2> search for candidate sidelink relay UEs, in accordance with TS 36.133
2> when evaluating the one or more detected sidelink relay UEs, apply layer 3 filtering as specified in 5.5.3.2 across measurements that concern the same ProSe Relay UE ID and using the filterCoefficient in SystemInformationBlockType19 (in coverage) or the preconfigured filterCoefficient as defined in 9.3 (out of coverage), before using the SD-RSRP measurement results;

NOTE 1: The details of the interaction with upper layers are up to UE implementation.
2> if the UE does not have a selected sidelink relay UE:
3> select a candidate sidelink relay UE which SD-RSRP exceeds q-RxLevMin included in either reselectionInfoIC (in coverage) or reselectionInfoOoC (out of coverage) by minHyst;
2> else if SD-RSRP of the currently selected sidelink relay UE is below q-RxLevMin included in either reselectionInfoIC (in coverage) or reselectionInfoOoC (out of coverage); orif upper layers indicate not to use the currently selected sidelink relay: (i.e. sidelink relay UE reselection):
3> select a candidate sidelink relay UE which SD-RSRP exceeds q-RxLevMin included in either reselectionInfoIC (in coverage) or reselectionInfoOoC (out of coverage) by minHyst;
2> else if the UE did not detect any candidate sidelink relay UE which SD-RSRP exceeds q-RxLevMin included in either reselectionInfoIC (in coverage) or reselectionInfoOoC (out of coverage) by minHyst:
3> consider no sidelink relay UE to be selected;

NOTE 2: The UE may perform sidelink relay UE reselection in a manner resulting in selection of the sidelink relay UE, amongst all candidate sidelink relay UEs meeting higher layer criteria, that has the best radio link quality. Further details, including interaction with upper layers, are up to UE implementation.

There currently exist certain challenge(s).

In RAN2#111e, RAN2 has made the below agreement regarding discovery of relay UE in case SL relay:

“For U2N relay, whether remote UE in CONNECTED state is allowed to transmit/receive discovery is based on configuration provided by serving gNB and detail is FFS. FFS for the case that the serving gNB is not SL-capable (if applicable)”

From the above agreement, it is observed that the gNB will assist remote UE to trigger discovery of a relay UE. However, the detailed mechanism is for further study.

In this concerned scenario, a remote UE is in RRC connected, therefore, the UE has RRC connection to its serving gNB. It may be considered beneficial to involve gNB's assistance to trigger when and how the UE performs a relay UE selection/reselection.

In the existing LTE SL relay mechanism, a remote UE will trigger selection/reselection of a relay UE only in case the measured Uu and/or sidelink (SL) radio channel quality (i.e., Reference Signal Received Power (RSRP)) is below a configured threshold. This mechanism may be reused as a baseline for NR SL based relay in Rel-17. Such mechanism is simple; however, it may be not sufficient.

### SUMMARY

Certain aspects of the present disclosure and their embodiments may provide solutions to these or other challenges. The existing LTE SL relay mechanism does not consider QoS metrics for remote UE. For a relay scenario, QoS satisfaction would be even more critical compared to a non-relay scenario. In the relay scenario, remote UE establishes connection to the Radio Access Network (RAN) via 2 hops, i.e., PC5 plus Uu. In this case, QoS satisfaction may be easily negatively impacted even if only one of the links has bad quality for a short period of time. Therefore, it is necessary to study how to improve the existing mechanism to also consider gNB's assistance and QoS metrics.

There are, proposed herein, various embodiments which address one or more of the issues disclosed herein.

According to some embodiments there is provided a method of providing communication between a remote device and a destination node over a relay path comprising at least one relay device. The method comprises obtaining an indication that a quality of service, QoS, metric is not meeting a QoS requirement, wherein the QoS metric is associated with one of: a traffic flow between the remote wireless device and the destination node, a radio bearer used in communication between the remote wireless device and the destination node; and a logical channel used in communication between the remote wireless device and the destination node; and responsive to the indication, initiating a recovery action to improve a QoS of the communication between the remote device and the destination node.

According to some embodiments there is provided a device. The device comprises processing circuitry, wherein the processing circuitry is configured to: obtain an indication that a quality of service, QoS, metric is not meeting a QoS requirement, wherein the QoS metric is associated with one of: a traffic flow between the remote wireless device and the destination node, a radio bearer used in communication between the remote wireless device and the destination node; and a logical channel used in communication between the remote wireless device and the destination node; and responsive to the indication, initiate a recovery action to improve a QoS of the communication between the remote device and the destination node. The device may comprise the remote device or the relay device. In some examples, the device comprises a base station in communication with the relay device or the remote device. The remote device and the relay device may comprise wireless terminal devices, for example user equipments (UEs).

Certain embodiments may provide one or more of the following technical advantage(s). In embodiments described herein, QoS metrics such as latency, power consumption and signaling overhead may be improved when providing communication between a remote device and a destination node. For example, a path (re)selection and/or reconfiguration procedure in UE-to-NW and UE-to-UE relay scenarios may take QoS requirements into account.

This may be particular important when the requirements on public safety and V2X use cases need to be met.

### BRIEF DESCRIPTION OF THE DRAWINGS

FIG. 1 illustrates a time-frequency grid;

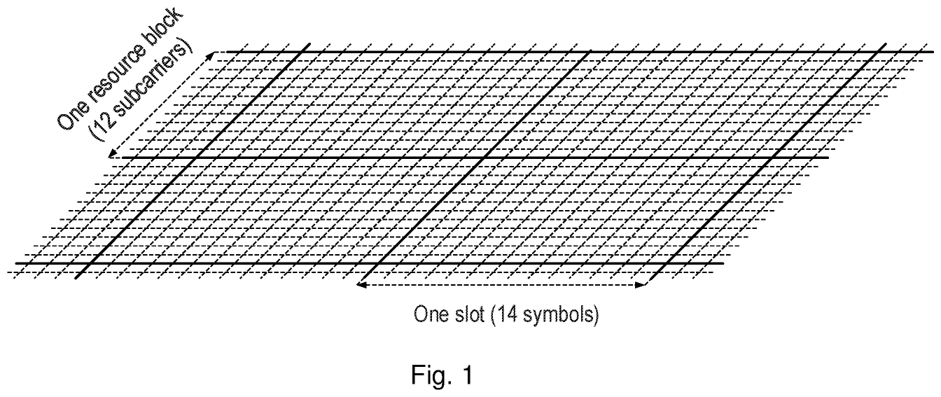

FIG. 2 illustrates an example Procedure for discovery procedure;

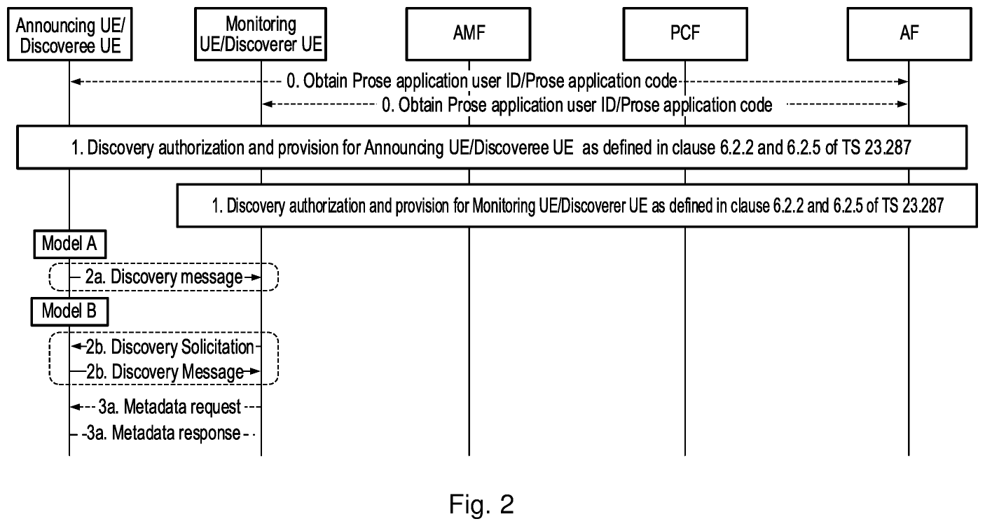

FIG. 3 illustrates a method of providing communication between a remote device and a destination node over a relay path comprising at least one relay device;

FIG. 4 illustrates a wireless network in accordance with some embodiments;

FIG. 5 illustrates a User Equipment in accordance with some embodiments;

FIG. 6 illustrates a virtualization environment in accordance with some embodiments;

FIG. 7 illustrates a telecommunication network connected via an intermediate network to a host computer in accordance with some embodiments;

FIG. 8 illustrates a host computer communicating via a base station with a user equipment over a partially wireless connection in accordance with some embodiments;

FIG. 9 illustrates methods implemented in a communication system including a host computer, a base station and a user equipment in accordance with some embodiments;

FIG. 10 illustrates methods implemented in a communication system including a host computer, a base station and a user equipment in accordance with some embodiments;

FIG. 11 illustrates methods implemented in a communication system including a host computer, a base station and a user equipment in accordance with some embodiments;

FIG. 12 illustrates methods implemented in a communication system including a host computer, a base station and a user equipment in accordance with some embodiments;

FIG. 13 illustrates a virtualization apparatus in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Embodiments described herein are described in the context of NR, i.e., remote UE and relay UE are deployed in a same or different NR cell. It will be appreciated that the concepts described herein may be applicable to other network structures.

The term “remote device”, “relay device” or “wireless terminal” may refer to any device that can access a communication network and also communicate with each other wirelessly. By way of example and not limitation, such devices may refer to a mobile terminal, a user equipment (UE), or other suitable devices. The UE may be, for example, a subscriber station, a portable subscriber station, a mobile station (MS) or an access terminal (AT), such as portable computers, image capture terminal devices e.g. digital cameras, gaming terminal devices, music storage and playback appliances, a mobile phone, a cellular phone, a smart phone, a tablet, a wearable device, a personal digital assistant (PDA), a vehicle, and the like. In this document, the terms “UE”, “device” (as in a remote device or relay device) and “wireless device” may be used interchangeably in some descriptions.

It will be appreciated that the remote device and relay device may comprise vehicle devices. For example, the remote device may be taking part in V2X communication utilizing the relay device as a relay.

The embodiments are also applicable to other relay scenarios including UE to network relay or UE to UE relay. The link between a remote device and relay device may be based on LTE sidelink, NR sidelink or any other direct communication between the remote device and the relay device. For example, any short range communication technology such as Wifi is equally applicable.

The Uu connection between relay UE and a base station may be, for example, LTE Uu or NR Uu. In the below embodiments, a grant issued by the gNB may be for a sidelink transmission between two UEs. The embodiments described herein may also be applicable to a relay scenario where the relay UE is configured with multiple connections (i.e., the number of connections is equal or larger than two) to the RAN (e.g., dual connectivity, carrier aggregation etc).

The embodiments described herein are applicable to both L2 relay and L3 relay based relay scenarios.

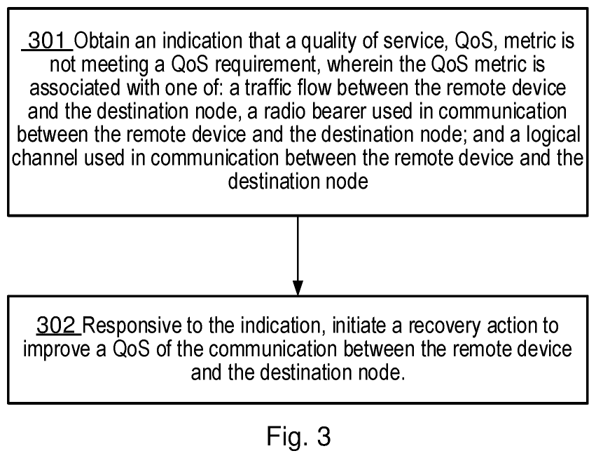

FIG. 3 illustrates a method of providing communication between a remote device and a destination node over a relay path comprising at least one relay device. The remote device and relay device may comprise wireless terminal devices, for example user equipments (UEs). The destination node may comprise a destination wireless terminal or a base station. For example, the communication between the remote device and the destination node may be UE to UE relay communication or UE to Network (NW) relay communication.

The method of FIG. 3 may be performed by the remote device, the relay device, or a base station in communication with the remote device or the relay device.

In step 301, the method comprises obtaining an indication that a quality of service, QoS, metric is not meeting a QoS requirement, wherein the QoS metric is associated with one of: a traffic flow between the remote wireless device and the destination node, a radio bearer used in communication between the remote wireless device and the destination node; and a logical channel used in communication between the remote wireless device and the destination node.

The QoS metric may comprise one or more of: bit rate, latency, jitter, packet loss, transmission error rate and any other QoS indicator such as Mean Opinion Score (MOS) etc.

In some examples the QoS metric is associated with a flow/bearer/LCH per hop or a flow per relay path.

For example, the QoS metric may be associated with a particular hop in the relay path, wherein the relay path comprises a plurality of hops. In these examples, the QoS requirement may be defined per hop. In other words, the QoS metric may be determined not to meet the QoS requirement if the QoS metric for the hop itself does not meet the QoS requirement. In other words, measurements on every single hop for a flow/bearer/LCH may have the risk of not fulfilling a QoS requirement for that particular hop.

Additionally or alternatively, the QoS metric may be said to not be a QoS requirement if, when combined with QoS metrics associated with other hops in the relay path, the QoS requirement is not met.

In some examples the QoS requirements may be defined for the entire relay path. For example, the QoS metric may be associated with the traffic flow over the relay path, wherein the relay path comprises a plurality of hops. In this example, the method may comprise obtaining the QoS metric by summarizing measurement results corresponding to the QoS metric for each hop in the relay path. For example, where the QoS metric is a latency metric, the latency measurements for all hops in the path may be summarized by taking an average of the latency measurements for all hops in the path.

In some examples, the method comprises periodically obtaining the QoS metric for each concerned flow, bearer or LCH. For each monitored QoS metric, there may be associated timer and/or threshold and/or a filtering used in the monitoring configured by a base station or another coordinator UE. The QoS metric may be measured by one of the remote device or one of the at least one relay devices in the relay path.

The device performing the method of FIG. 3 may therefore obtain the indication of the QoS metric in a number of ways. The QoS metric may be measured at the device. For example, the latency of a particular hop may be measured by the devices at each end of the hop. In some examples, measurement results of the QoS metric may be received from another node in the relay path. In some examples, the QoS metric is calculated by the device. For example, the device may calculate the QoS metric based on any combination of received measurements and measurements made by the device performing the method.

In some examples, the measuring of the QoS metric(s) may be performed by one or more relay devices and the remote device. For example, a relay device may monitor a flow/bearer/LCH on a hop towards the destination node (gNB or destination wireless terminal) while the remote device may also monitor a flow/bearer/LCH on the hop towards the relay device. The relay device may only monitor the flow(s)/bearer(s)/LCH(s) which carry the traffic from the remote device, for a given flow(s)/bearer(s)/LCH(s) received from the remote device, the relay device may determine the associated flow(s)/bearer(s)/LCH(s) on the hop towards the destination node, where association means the same traffic of the remote device is transmitted to the target node over the associated flow(s)/bearer(s)/LCH(s), and the end to end QoS may be estimated based on the monitoring results of the associated flow(s)/bearer(s)/LCH(s).

For example, the measuring may be performed by a UE in terms of metrics such as bit rate, latency, jitter, packet loss, transmission error rate etc. The UE may monitor its own QoS results, meanwhile, the UE may also receive QoS results of other UEs on the path. If there are any results which indicates a risk that the QoS is not fulfilled on the E2E path, the UE may trigger corresponding actions. The UE may also summarize the results of its own and results from other UEs to get a overall evaluation.

In some embodiments, which radio bearers/flows/logical channels that the remote device and/or at least one relay device monitors may be determinate autonomously by the remote device or relay device itself. This autonomous determination may, for example, be based on the QoS traffic that needs to be handled. In some examples, which radio bearers/flows/logical channels that the remote device monitors may be controlled by the relay device, for example, during the PC5 connection establishment. In some examples, which radio bearers/flows/logical channels that the remote device and/or at least one relay device monitors may be controlled by the base station (e.g. gNB) when requesting the configuration (i.e., by the relay UE) to establish a relay patch connection.

As described previously, in some examples, the relay device and/or remote device may receive one or more measurements of a QoS metric from other nodes in the relay path. In some examples, the measurements may be transmitted via Radio Resource Control (RRC) signaling, PC5-S signaling or MAC-CE signaling. In some examples, the measurement may be distributed to all nodes in the relay path. Alternatively, the QoS measurements may be transmitted to other nodes in the relay path via control PDUs of a protocol layer such as PDCP, RLC, or adaption layer.

In some examples, the measurement(s) if the QoS metric may be transmitted to a base station. Similarly to as described above, the measurements may be transmitted to the base station by RRC signaling, or MAC-CE. Alternatively, the measurement result(s) may be transmitted to the base station via control PDUs of a protocol layer such as PDCP, RLC, or adaption layer. A relay device or the remote device may therefore indicate to a base station (e.g. gNB) that the QoS metric is not meeting the QoS requirement by transmitting a measurement result of the QoS metric to the base station.

The measurement result(s) may also be received at a node in the relay path or at a base station with one or more of the following information:
a wireless device identification (UE IDs) associated with the measurement result, for example an identification of the remote device and/or a relay device associated with a particular hop that the measurement relates to;
a traffic flow, radio bearer or logical channel identification associated with the measurement result;
a cause of the failure to meet the QoS requirement;
a identification of a hop associated with the measurement results; and
an indication of whether the measurement result is for a traffic flow, radio bearer or a logical channel associated with the relay traffic.

In step 302 the method comprises, responsive to the indication, initiating a recovery action to improve a QoS of the communication between the remote device and the destination node.

The recovery action may be performed by the relay device, the remote device, the base station, any combination of these devices, or any other device in the network. The device performing the method of FIG. 3 may perform the recovery action, or may initiate the recovery action in other nodes by transmitting signaling to one or more other nodes in the network.

The recovery action may comprise: performing resource reselection and/or resource pool reconfiguration at the remote device or the relay device.

In some examples, the remote device or relay device performs resource selection autonomously (for example Mode 2 as described in the background section above). In these examples, the recovery action may comprise the remote device or relay device triggering a Random Access Channel, RACH, procedure with a base station to enter RRC_CONNECTED, and requesting that the base station indicate new radio resources and/or a new resource pool configuration. For UE to UE relay this may trigger the remote UE and/or the relay UE to enter RRC connected mode if the remote UE is currently in RRC idle/inactive mode.

In some embodiments, where the quality of service metric is associated with a radio bearer or flow for a particular hop in the relay path, the recovery action comprises releasing the radio bearer or flow at the particular hop. When releasing the radio bearer, the device that performs the release may inform, via PC5 RRC, its peer device with which the relay path is established (e.g. the device at the other end of the hop). Further, the device may inform the base station (e.g. gNB), for example via uplink (UL) Uu, that a certain radio bearer linked to a given relay path has been released. In some examples, the recovery action further comprises releasing the radio bearer or flow at one or more other hops in the relay path.

In some embodiments, the recovery action comprises selecting a new relay device to replace one of the at least one relay devices in the relay path. In some examples, the recovery action comprises selecting a new relay path to replace the relay path. In some embodiments, the selection of a new relay device or new relay path may be performed when the QoS requirement comprises a requirement that a threshold number of traffic flows meet respective quality of service requirements. For example, the method may comprise selecting a new relay device or a new relay path responsive to a predetermined number of traffic flows failing to meet their responsive QoS requirements.

In some embodiments, the recovery action comprises releases some other radio bearers(s) and/or flow(s) which are associated with a lower priority than the radio bearer or traffic flow associated with the QoS metric that is not meeting the QoS requirement. By releasing other radio bearer(s) or traffic flows, more resources may be available for the higher priority radio bearer or flow associated with the QoS metric not meeting the QoS requirement. By making more resources available, the higher priority radio bearer or traffic flow may be reconfigured such that the QoS metric meets the QoS requirement.

In some embodiments, the recovery action comprises the remote device and/or the relay device remapping a traffic flow associated with the QoS metric that is not meeting the QoS requirement from one radio bearer to another radio bearer. In some embodiments the recovery action comprises reconfiguring the radio bearer carrying the traffic flow associated with the QoS metric. This is may be valid for UE to NW and UE to UE relay.

In some embodiments, for terminal device to NW relay, the remote/relay device may inform the base station (for example, via dedicated RRC signaling) that a QoS requirement for a certain traffic flow cannot be guaranteed. In response to this information, the base station may initiate the recovery action by remapping the uplink UL and/or downlink DL traffic flow from one UL/DL radio bearer to another UL/DL radio bearer or by reconfiguring the radio bearer carrying the traffic flow.

In some embodiments, the recovery action may comprise, responsive to the QoS metric associated with a flow over a particular hop not meeting a QoS Requirement, prioritising the same flow on other hops in the relay path in order to compensate for the flow not meeting QoS requirements on the particular hop.

In some embodiments, recovery action comprises the relay device changing to a different BWP/carrier/cell/gNB. The remote device may transmit an indication to the relay device that the QoS requirements on a given radio bearer or traffic flow cannot be met and the relay device may decide to reconfigure some configuration over PC5 or ask a base station for a new configuration.

In some embodiments, the recovery action comprises the remote device changing to a different Subcarrier Spacing (SCS) or Bandwidth Part (BWP) on, for example, the PC5 link. The remote device may send an indication to the relay device that the QoS requirements on a given radio bearer or traffic flow cannot be met and may ask for a new configuration with the relay device. In this case, the relay device may reconfigure autonomously the remote device, for example, over PC5, or may request a new configuration from a base station (e.g. gNB).

In some embodiments, the base station may transmit signaling the one of the remote device or the relay device to configure which recovery action the remote device and/or relay device may perform in response to an indication of a QoS metric not meeting the QoS requirement. In some examples, which recovery action the remote device and/or relay device may apply is configured by the base station via system information, RRC signaling, MAC CE or DCI.

In some embodiments, a UE capability is defined for a remote device or relay device to indicate whether the remote device or relay device supports QoS monitoring over PC5 or over Uu (i.e., this may be related to relay scenarios or not).

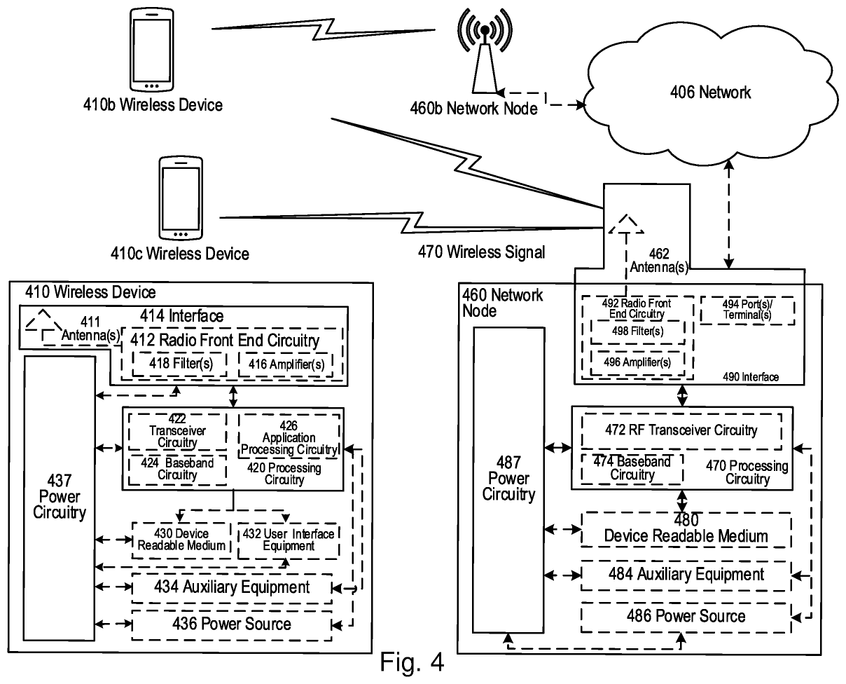

FIG. 4 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 406, network nodes 460 and 460b, and WDs 410, 410b, and 410c. In practice, a wireless network may further include any additional elements suitable to support communication between wireless devices or between a UE and another communication device, such as a landline telephone, a service provider, or any other network node or end device. Of the illustrated components, network node 460 and wireless device (WD) 410 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 406 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 460 and WD 410 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 460 includes processing circuitry 470, device readable medium 480, interface 490, auxiliary equipment 484, power source 486, power circuitry 487, and antenna 462. Although network node 460 illustrated in the example wireless network of FIG. 4 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 460 are depicted as single boxes located within a larger box, or nested within multiple boxes, in practice, a network node may comprise multiple different physical components that make up a single illustrated component (e.g., device readable medium 480 may comprise multiple separate hard drives as well as multiple RAM modules).

Similarly, network node 460 may be composed of multiple physically separate components (e.g., a NodeB component and a RNC component, or a BTS component and a BSC component, etc.), which may each have their own respective components. In certain scenarios in which network node 460 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 460 may be configured to support multiple radio access technologies (RATs). In such embodiments, some components may be duplicated (e.g., separate device readable medium 480 for the different RATs) and some components may be reused (e.g., the same antenna 462 may be shared by the RATs). Network node 460 may also include multiple sets of the various illustrated components for different wireless technologies integrated into network node 460, such as, for example, GSM, WCDMA, LTE, NR, WiFi, or Bluetooth wireless technologies. These wireless technologies may be integrated into the same or different chip or set of chips and other components within network node 460.

Processing circuitry 470 is configured to perform any determining, calculating, or similar operations (e.g., certain obtaining operations) described herein as being provided by a network node. These operations performed by processing circuitry 470 may include processing information obtained by processing circuitry 470 by, for example, converting the obtained information into other information, comparing the obtained information or converted information to information stored in the network node, and/or performing one or more operations based on the obtained information or converted information, and as a result of said processing making a determination.

Processing circuitry 470 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 460 components, such as device readable medium 480, network node 460 functionality. For example, processing circuitry 470 may execute instructions stored in device readable medium 480 or in memory within processing circuitry 470. Such functionality may include providing any of the various wireless features, functions, or benefits discussed herein. In some embodiments, processing circuitry 470 may include a system on a chip (SOC).

In some embodiments, processing circuitry 470 may include one or more of radio frequency (RF) transceiver circuitry 472 and baseband processing circuitry 474. In some embodiments, radio frequency (RF) transceiver circuitry 472 and baseband processing circuitry 474 may be on separate chips (or sets of chips), boards, or units, such as radio units and digital units. In alternative embodiments, part or all of RF transceiver circuitry 472 and baseband processing circuitry 474 may be on the same chip or set of chips, boards, or units

In certain embodiments, some or all of the functionality described herein as being provided by a network node, base station, eNB or other such network device may be performed by processing circuitry 470 executing instructions stored on device readable medium 480 or memory within processing circuitry 470. In alternative embodiments, some or all of the functionality may be provided by processing circuitry 470 without executing instructions stored on a separate or discrete device readable medium, such as in a hard-wired manner. In any of those embodiments, whether executing instructions stored on a device readable storage medium or not, processing circuitry 470 can be configured to perform the described functionality. The benefits provided by such functionality are not limited to processing circuitry 470 alone or to other components of network node 460, but are enjoyed by network node 460 as a whole, and/or by end users and the wireless network generally.

Device readable medium 480 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 470. Device readable medium 480 may store any suitable instructions, data or information, including a computer program, software, an application including one or more of logic, rules, code, tables, etc. and/or other instructions capable of being executed by processing circuitry 470 and, utilized by network node 460. Device readable medium 480 may be used to store any calculations made by processing circuitry 470 and/or any data received via interface 490. In some embodiments, processing circuitry 470 and device readable medium 480 may be considered to be integrated.

Interface 490 is used in the wired or wireless communication of signalling and/or data between network node 460, network 406, and/or WDs 410. As illustrated, interface 490 comprises port(s)/terminal(s) 494 to send and receive data, for example to and from network 406 over a wired connection. Interface 490 also includes radio front end circuitry 492 that may be coupled to, or in certain embodiments a part of, antenna 462. Radio front end circuitry 492 comprises filters 498 and amplifiers 496. Radio front end circuitry 492 may be connected to antenna 462 and processing circuitry 470. Radio front end circuitry may be configured to condition signals communicated between antenna 462 and processing circuitry 470. Radio front end circuitry 492 may receive digital data that is to be sent out to other network nodes or WDs via a wireless connection. Radio front end circuitry 492 may convert the digital data into a radio signal having the appropriate channel and bandwidth parameters using a combination of filters 498 and/or amplifiers 496. The radio signal may then be transmitted via antenna 462. Similarly, when receiving data, antenna 462 may collect radio signals which are then converted into digital data by radio front end circuitry 492. The digital data may be passed to processing circuitry 470. In other embodiments, the interface may comprise different components and/or different combinations of components.

In certain alternative embodiments, network node 460 may not include separate radio front end circuitry 492, instead, processing circuitry 470 may comprise radio front end circuitry and may be connected to antenna 462 without separate radio front end circuitry 492. Similarly, in some embodiments, all or some of RF transceiver circuitry 472 may be considered a part of interface 490. In still other embodiments, interface 490 may include one or more ports or terminals 494, radio front end circuitry 492, and RF transceiver circuitry 472, as part of a radio unit (not shown), and interface 490 may communicate with baseband processing circuitry 474, which is part of a digital unit (not shown).

Antenna 462 may include one or more antennas, or antenna arrays, configured to send and/or receive wireless signals. Antenna 462 may be coupled to radio front end circuitry 490 and may be any type of antenna capable of transmitting and receiving data and/or signals wirelessly. In some embodiments, antenna 462 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 462 may be separate from network node 460 and may be connectable to network node 460 through an interface or port.

Antenna 462, interface 490, and/or processing circuitry 470 may be configured to perform any receiving operations and/or certain obtaining operations described herein as being performed by a network node. Any information, data and/or signals may be received from a wireless device, another network node and/or any other network equipment. Similarly, antenna 462, interface 490, and/or processing circuitry 470 may be configured to perform any transmitting operations described herein as being performed by a network node. Any information, data and/or signals may be transmitted to a wireless device, another network node and/or any other network equipment.

Power circuitry 487 may comprise, or be coupled to, power management circuitry and is configured to supply the components of network node 460 with power for performing the functionality described herein. Power circuitry 487 may receive power from power source 486. Power source 486 and/or power circuitry 487 may be configured to provide power to the various components of network node 460 in a form suitable for the respective components (e.g., at a voltage and current level needed for each respective component). Power source 486 may either be included in, or external to, power circuitry 487 and/or network node 460. For example, network node 460 may be connectable to an external power source (e.g., an electricity outlet) via an input circuitry or interface such as an electrical cable, whereby the external power source supplies power to power circuitry 487. As a further example, power source 486 may comprise a source of power in the form of a battery or battery pack which is connected to, or integrated in, power circuitry 487. The battery may provide backup power should the external power source fail. Other types of power sources, such as photovoltaic devices, may also be used.

Alternative embodiments of network node 460 may include additional components beyond those shown in FIG. 4 that may be responsible for providing certain aspects of the network node's functionality, including any of the functionality described herein and/or any functionality necessary to support the subject matter described herein. For example, network node 460 may include user interface equipment to allow input of information into network node 460 and to allow output of information from network node 460. This may allow a user to perform diagnostic, maintenance, repair, and other administrative functions for network node 460.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V21), vehicle-to-everything (V2X) and may in this case be referred to as a D2D communication device. As described above the D2D communication may be utilised to provide a relay path in the network. For example the WD 410 may instead communicate with the network node 460 via the WD 410c. Or, the WD may communicate with the WD 410b using the WD 410c as a relay node. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 410 includes antenna 411, interface 414, processing circuitry 420, device readable medium 430, user interface equipment 432, auxiliary equipment 434, power source 436 and power circuitry 437. WD 410 may include multiple sets of one or more of the illustrated components for different wireless technologies supported by WD 410, such as, for example, GSM, WCDMA, LTE, NR, WiFi, WiMAX, or Bluetooth wireless technologies, just to mention a few. These wireless technologies may be integrated into the same or different chips or set of chips as other components within WD 410.

Antenna 411 may include one or more antennas or antenna arrays, configured to send and/or receive wireless signals, and is connected to interface 414. In certain alternative embodiments, antenna 411 may be separate from WD 410 and be connectable to WD 410 through an interface or port. Antenna 411, interface 414, and/or processing circuitry 420 may be configured to perform any receiving or transmitting operations described herein as being performed by a WD. Any information, data and/or signals may be received from a network node and/or another WD. In some embodiments, radio front end circuitry and/or antenna 411 may be considered an interface.

As illustrated, interface 414 comprises radio front end circuitry 412 and antenna 411. Radio front end circuitry 412 comprise one or more filters 418 and amplifiers 416. Radio front end circuitry 414 is connected to antenna 411 and processing circuitry 420, and is configured to condition signals communicated between antenna 411 and processing circuitry 420. Radio front end circuitry 412 may be coupled to or a part of antenna 411. In some embodiments, WD 410 may not include separate radio front end circuitry 412; rather, processing circuitry 420 may comprise radio front end circuitry and may be connected to antenna 411. Similarly, in some embodiments, some or all of RF transceiver circuitry 422 may be considered a part of interface 414. Radio front end circuitry 412 may receive digital data that is to be sent out to other network nodes or WDs via a wireless connection. Radio front end circuitry 412 may convert the digital data into a radio signal having the appropriate channel and bandwidth parameters using a combination of filters 418 and/or amplifiers 416. The radio signal may then be transmitted via antenna 411. Similarly, when receiving data, antenna 411 may collect radio signals which are then converted into digital data by radio front end circuitry 412. The digital data may be passed to processing circuitry 420. In other embodiments, the interface may comprise different components and/or different combinations of components.

Processing circuitry 420 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 410 components, such as device readable medium 430, WD 410 functionality. Such functionality may include providing any of the various wireless features or benefits discussed herein. For example, processing circuitry 420 may execute instructions stored in device readable medium 430 or in memory within processing circuitry 420 to provide the functionality disclosed herein.

As illustrated, processing circuitry 420 includes one or more of RF transceiver circuitry 422, baseband processing circuitry 424, and application processing circuitry 426. In other embodiments, the processing circuitry may comprise different components and/or different combinations of components. In certain embodiments processing circuitry 420 of WD 410 may comprise a SOC. In some embodiments, RF transceiver circuitry 422, baseband processing circuitry 424, and application processing circuitry 426 may be on separate chips or sets of chips. In alternative embodiments, part or all of baseband processing circuitry 424 and application processing circuitry 426 may be combined into one chip or set of chips, and RF transceiver circuitry 422 may be on a separate chip or set of chips. In still alternative embodiments, part or all of RF transceiver circuitry 422 and baseband processing circuitry 424 may be on the same chip or set of chips, and application processing circuitry 426 may be on a separate chip or set of chips. In yet other alternative embodiments, part or all of RF transceiver circuitry 422, baseband processing circuitry 424, and application processing circuitry 426 may be combined in the same chip or set of chips. In some embodiments, RF transceiver circuitry 422 may be a part of interface 414. RF transceiver circuitry 422 may condition RF signals for processing circuitry 420.

In certain embodiments, some or all of the functionality described herein as being performed by a WD may be provided by processing circuitry 420 executing instructions stored on device readable medium 430, which in certain embodiments may be a computer-readable storage medium. In alternative embodiments, some or all of the functionality may be provided by processing circuitry 420 without executing instructions stored on a separate or discrete device readable storage medium, such as in a hard-wired manner. In any of those particular embodiments, whether executing instructions stored on a device readable storage medium or not, processing circuitry 420 can be configured to perform the described functionality. The benefits provided by such functionality are not limited to processing circuitry 420 alone or to other components of WD 410, but are enjoyed by WD 410 as a whole, and/or by end users and the wireless network generally.

Processing circuitry 420 may be configured to perform any determining, calculating, or similar operations (e.g., certain obtaining operations) described herein as being performed by a WD. These operations, as performed by processing circuitry 420, may include processing information obtained by processing circuitry 420 by, for example, converting the obtained information into other information, comparing the obtained information or converted information to information stored by WD 410, and/or performing one or more operations based on the obtained information or converted information, and as a result of said processing making a determination.

Device readable medium 430 may be operable to store a computer program, software, an application including one or more of logic, rules, code, tables, etc. and/or other instructions capable of being executed by processing circuitry 420. Device readable medium 430 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 420. In some embodiments, processing circuitry 420 and device readable medium 430 may be considered to be integrated.

User interface equipment 432 may provide components that allow for a human user to interact with WD 410. Such interaction may be of many forms, such as visual, audial, tactile, etc. User interface equipment 432 may be operable to produce output to the user and to allow the user to provide input to WD 410. The type of interaction may vary depending on the type of user interface equipment 432 installed in WD 410. For example, if WD 410 is a smart phone, the interaction may be via a touch screen; if WD 410 is a smart meter, the interaction may be through a screen that provides usage (e.g., the number of gallons used) or a speaker that provides an audible alert (e.g., if smoke is detected). User interface equipment 432 may include input interfaces, devices and circuits, and output interfaces, devices and circuits. User interface equipment 432 is configured to allow input of information into WD 410, and is connected to processing circuitry 420 to allow processing circuitry 420 to process the input information. User interface equipment 432 may include, for example, a microphone, a proximity or other sensor, keys/buttons, a touch display, one or more cameras, a USB port, or other input circuitry. User interface equipment 432 is also configured to allow output of information from WD 410, and to allow processing circuitry 420 to output information from WD 410. User interface equipment 432 may include, for example, a speaker, a display, vibrating circuitry, a USB port, a headphone interface, or other output circuitry. Using one or more input and output interfaces, devices, and circuits, of user interface equipment 432, WD 410 may communicate with end users and/or the wireless network, and allow them to benefit from the functionality described herein.

Auxiliary equipment 434 is operable to provide more specific functionality which may not be generally performed by WDs. This may comprise specialized sensors for doing measurements for various purposes, interfaces for additional types of communication such as wired communications etc. The inclusion and type of components of auxiliary equipment 434 may vary depending on the embodiment and/or scenario.

Power source 436 may, in some embodiments, be in the form of a battery or battery pack. Other types of power sources, such as an external power source (e.g., an electricity outlet), photovoltaic devices or power cells, may also be used. WD 410 may further comprise power circuitry 437 for delivering power from power source 436 to the various parts of WD 410 which need power from power source 436 to carry out any functionality described or indicated herein. Power circuitry 437 may in certain embodiments comprise power management circuitry. Power circuitry 437 may additionally or alternatively be operable to receive power from an external power source; in which case WD 410 may be connectable to the external power source (such as an electricity outlet) via input circuitry or an interface such as an electrical power cable. Power circuitry 437 may also in certain embodiments be operable to deliver power from an external power source to power source 436. This may be, for example, for the charging of power source 436. Power circuitry 437 may perform any formatting, converting, or other modification to the power from power source 436 to make the power suitable for the respective components of WD 410 to which power is supplied.

The method as described with reference to FIG. 3 may be performed by the WD 410 or the network node 460. In some examples, the method may be performed by a relay device providing a relay between the wireless device 410 and the network node 460.

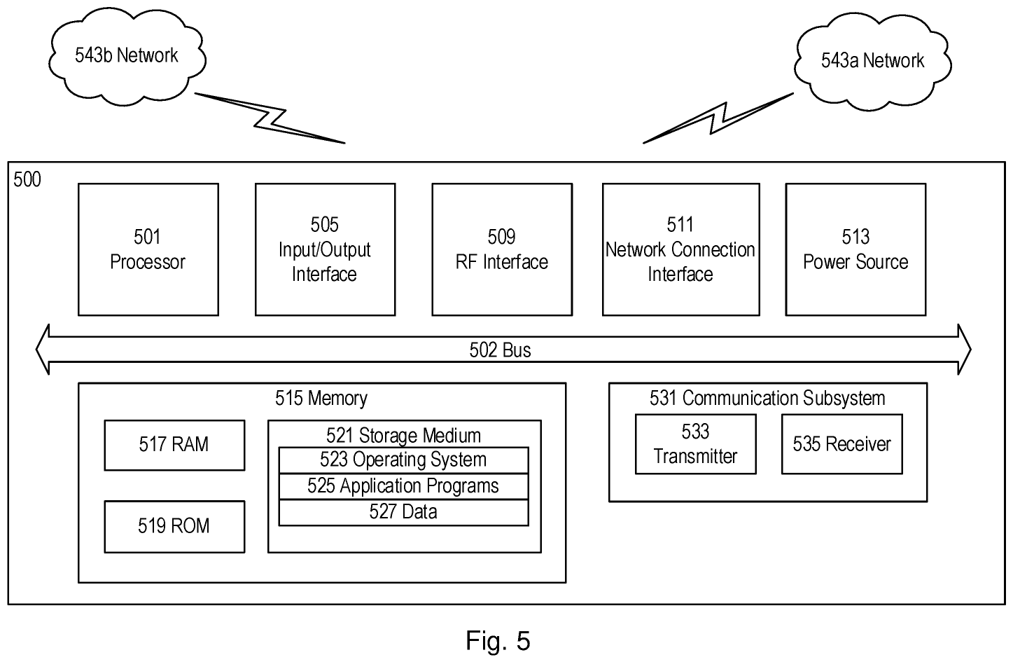

FIG. 5 Illustrates a User Equipment in Accordance with Some Embodiments

FIG. 5 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 500 may be any UE identified by the 3rd Generation Partnership Project (3GPP), including a NB-IoT UE, a machine type communication (MTC) UE, and/or an enhanced MTC (eMTC) UE. UE 500, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 500 includes processing circuitry 501 that is operatively coupled to input/output interface 505, radio frequency (RF) interface 509, network connection interface 511, memory 515 including random access memory (RAM) 517, read-only memory (ROM) 519, and storage medium 521 or the like, communication subsystem 531, power source 533, and/or any other component, or any combination thereof. Storage medium 521 includes operating system 523, application program 525, and data 527. In other embodiments, storage medium 521 may include other similar types of information. Certain UEs may utilize all of the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In the depicted embodiment, input/output interface 505 may be configured to provide a communication interface to an input device, output device, or input and output device. UE 500 may be configured to use an output device via input/output interface 505. An output device may use the same type of interface port as an input device. For example, a USB port may be used to provide input to and output from UE 500. The output device may be a speaker, a sound card, a video card, a display, a monitor, a printer, an actuator, an emitter, a smartcard, another output device, or any combination thereof. UE 500 may be configured to use an input device via input/output interface 505 to allow a user to capture information into UE 500. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 509 may be configured to provide a communication interface to RF components such as a transmitter, a receiver, and an antenna. Network connection interface 511 may be configured to provide a communication interface to network 543a. Network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. Network connection interface 511 may be configured to include a receiver and a transmitter interface used to communicate with one or more other devices over a communication network according to one or more communication protocols, such as Ethernet, TCP/IP, SONET, ATM, or the like. Network connection interface 511 may implement receiver and transmitter functionality appropriate to the communication network links (e.g., optical, electrical, and the like). The transmitter and receiver functions may share circuit components, software or firmware, or alternatively may be implemented separately.

RAM 517 may be configured to interface via bus 502 to processing circuitry 501 to provide storage or caching of data or computer instructions during the execution of software programs such as the operating system, application programs, and device drivers. ROM 519 may be configured to provide computer instructions or data to processing circuitry 501. For example, ROM 519 may be configured to store invariant low-level system code or data for basic system functions such as basic input and output (I/O), startup, or reception of keystrokes from a keyboard that are stored in a non-volatile memory. Storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 521 may be configured to include operating system 523, application program 525 such as a web browser application, a widget or gadget engine or another application, and data file 527. Storage medium 521 may store, for use by UE 500, any of a variety of various operating systems or combinations of operating systems.

Storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 521 may allow UE 500 to access computer-executable instructions, application programs or the like, stored on transitory or non-transitory memory media, to off-load data, or to upload data. An article of manufacture, such as one utilizing a communication system may be tangibly embodied in storage medium 521, which may comprise a device readable medium.

In FIG. 5, processing circuitry 501 may be configured to communicate with network 543b using communication subsystem 531. Network 543a and network 543b may be the same network or networks or different network or networks. Communication subsystem 531 may be configured to include one or more transceivers used to communicate with network 543b. For example, communication subsystem 531 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software or firmware, or alternatively may be implemented separately.

In the illustrated embodiment, the communication functions of communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 531 may include cellular communication, Wi-Fi communication, Bluetooth communication, and GPS communication. Network 543b may encompass wired and/or wireless networks such as a local-area network (LAN), a wide-area network (WAN), a computer network, a wireless network, a telecommunications network, another like network or any combination thereof. For example, network 543b may be a cellular network, a Wi-Fi network, and/or a near-field network. Power source 513 may be configured to provide alternating current (AC) or direct current (DC) power to components of UE 500.

The features, benefits and/or functions described herein may be implemented in one of the components of UE 500 or partitioned across multiple components of UE 500. Further, the features, benefits, and/or functions described herein may be implemented in any combination of hardware, software or firmware. In one example, communication subsystem 531 may be configured to include any of the components described herein. Further, processing circuitry 501 may be configured to communicate with any of such components over bus 502. In another example, any of such components may be represented by program instructions stored in memory that when executed by processing circuitry 501 perform the corresponding functions described herein. In another example, the functionality of any of such components may be partitioned between processing circuitry 501 and communication subsystem 531. In another example, the non-computationally intensive functions of any of such components may be implemented in software or firmware and the computationally intensive functions may be implemented in hardware.

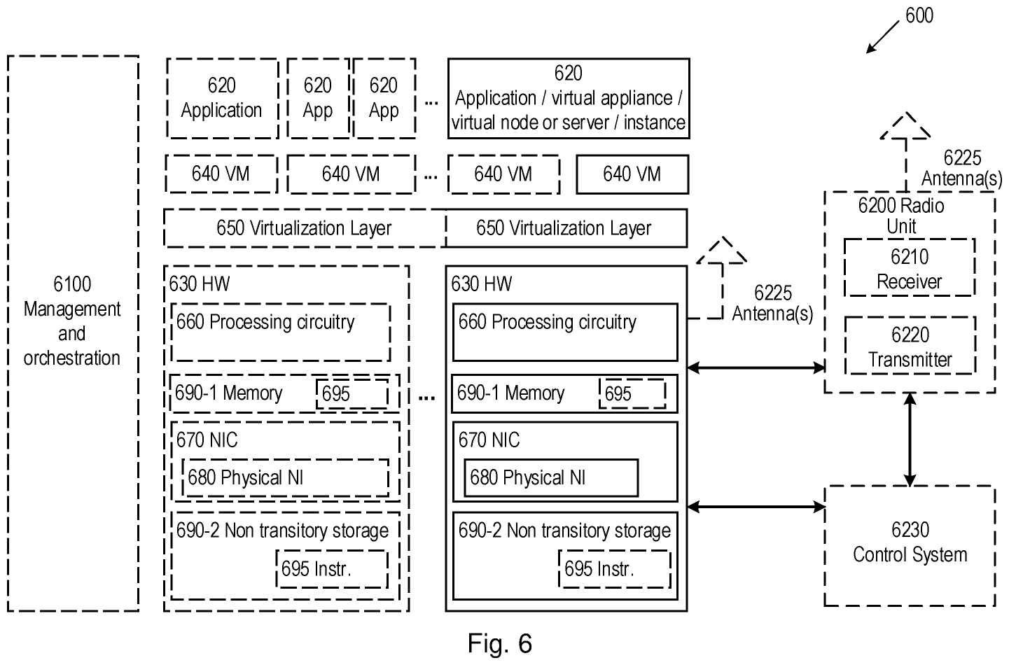

FIG. 6 Illustrates a Virtualization Environment in Accordance with Some Embodiments

FIG. 6 is a schematic block diagram illustrating a virtualization environment 600 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 600 hosted by one or more of hardware nodes 630. Further, in embodiments in which the virtual node is not a radio access node or does not require radio connectivity (e.g., a core network node), then the network node may be entirely virtualized.

The functions may be implemented by one or more applications 620 (which may alternatively be called software instances, virtual appliances, network functions, virtual nodes, virtual network functions, etc.) operative to implement some of the features, functions, and/or benefits of some of the embodiments disclosed herein. Applications 620 are run in virtualization environment 600 which provides hardware 630 comprising processing circuitry 660 and memory 690. Memory 690 contains instructions 695 executable by processing circuitry 660 whereby application 620 is operative to provide one or more of the features, benefits, and/or functions disclosed herein.

Virtualization environment 600, comprises general-purpose or special-purpose network hardware devices 630 comprising a set of one or more processors or processing circuitry 660, which may be commercial off-the-shelf (COTS) processors, dedicated Application Specific Integrated Circuits (ASICs), or any other type of processing circuitry including digital or analog hardware components or special purpose processors. Each hardware device may comprise memory 690-1 which may be non-persistent memory for temporarily storing instructions 695 or software executed by processing circuitry 660. Each hardware device may comprise one or more network interface controllers (NICs) 670, also known as network interface cards, which include physical network interface 680. Each hardware device may also include non-transitory, persistent, machine-readable storage media 690-2 having stored therein software 695 and/or instructions executable by processing circuitry 660. Software 695 may include any type of software including software for instantiating one or more virtualization layers 650 (also referred to as hypervisors), software to execute virtual machines 640 as well as software allowing it to execute functions, features and/or benefits described in relation with some embodiments described herein.

Virtual machines 640, comprise virtual processing, virtual memory, virtual networking or interface and virtual storage, and may be run by a corresponding virtualization layer 650 or hypervisor. Different embodiments of the instance of virtual appliance 620 may be implemented on one or more of virtual machines 640, and the implementations may be made in different ways.

During operation, processing circuitry 660 executes software 695 to instantiate the hypervisor or virtualization layer 650, which may sometimes be referred to as a virtual machine monitor (VMM). Virtualization layer 650 may present a virtual operating platform that appears like networking hardware to virtual machine 640.

As shown in FIG. 6, hardware 630 may be a standalone network node with generic or specific components. Hardware 630 may comprise antenna 6225 and may implement some functions via virtualization. Alternatively, hardware 630 may be part of a larger cluster of hardware (e.g. such as in a data center or customer premise equipment (CPE)) where many hardware nodes work together and are managed via management and orchestration (MANO) 6100, which, among others, oversees lifecycle management of applications 620.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 640 may be a software implementation of a physical machine that runs programs as if they were executing on a physical, non-virtualized machine. Each of virtual machines 640, and that part of hardware 630 that executes that virtual machine, be it hardware dedicated to that virtual machine and/or hardware shared by that virtual machine with others of the virtual machines 640, forms a separate virtual network elements (VNE).

Still in the context of NFV, Virtual Network Function (VNF) is responsible for handling specific network functions that run in one or more virtual machines 640 on top of hardware networking infrastructure 630 and corresponds to application 620 in FIG. 6.

In some embodiments, one or more radio units 6200 that each include one or more transmitters 6220 and one or more receivers 6210 may be coupled to one or more antennas 6225. Radio units 6200 may communicate directly with hardware nodes 630 via one or more appropriate network interfaces and may be used in combination with the virtual components to provide a virtual node with radio capabilities, such as a radio access node or a base station.

In some embodiments, some signalling can be effected with the use of control system 6230 which may alternatively be used for communication between the hardware nodes 630 and radio units 6200.

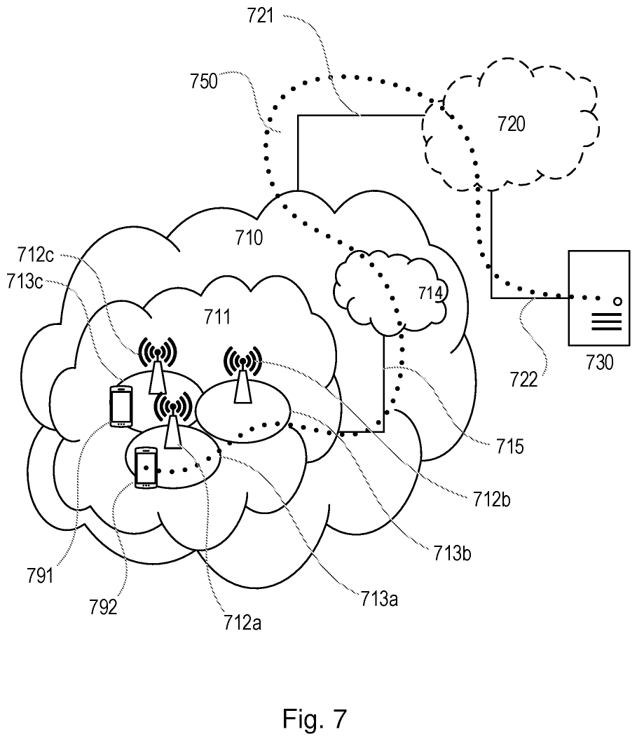

FIG. 7 illustrates a telecommunication network connected via an intermediate network to a host computer in accordance with some embodiments.

With reference to FIG. 7, in accordance with an embodiment, a communication system includes telecommunication network 710, such as a 3GPP-type cellular network, which comprises access network 711, such as a radio access network, and core network 714. Access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to core network 714 over a wired or wireless connection 715. A first UE 791 located in coverage area 713c is configured to wirelessly connect to, or be paged by, the corresponding base station 712c. A second UE 792 in coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

Telecommunication network 710 is itself connected to host computer 730, which may be embodied in the hardware and/or software of a standalone server, a cloud-implemented server, a distributed server or as processing resources in a server farm. Host computer 730 may be under the ownership or control of a service provider, or may be operated by the service provider or on behalf of the service provider. Connections 721 and 722 between telecommunication network 710 and host computer 730 may extend directly from core network 714 to host computer 730 or may go via an optional intermediate network 720. Intermediate network 720 may be one of, or a combination of more than one of, a public, private or hosted network; intermediate network 720, if any, may be a backbone network or the Internet; in particular, intermediate network 720 may comprise two or more sub-networks (not shown).

The communication system of FIG. 7 as a whole enables connectivity between the connected UEs 791, 792 and host computer 730. The connectivity may be described as an over-the-top (OTT) connection 750. Host computer 730 and the connected UEs 791, 792 are configured to communicate data and/or signaling via OTT connection 750, using access network 711, core network 714, any intermediate network 720 and possible further infrastructure (not shown) as intermediaries. OTT connection 750 may be transparent in the sense that the participating communication devices through which OTT connection 750 passes are unaware of routing of uplink and downlink communications. For example, base station 712 may not or need not be informed about the past routing of an incoming downlink communication with data originating from host computer 730 to be forwarded (e.g., handed over) to a connected UE 791. Similarly, base station 712 need not be aware of the future routing of an outgoing uplink communication originating from the UE 791 towards the host computer 730.

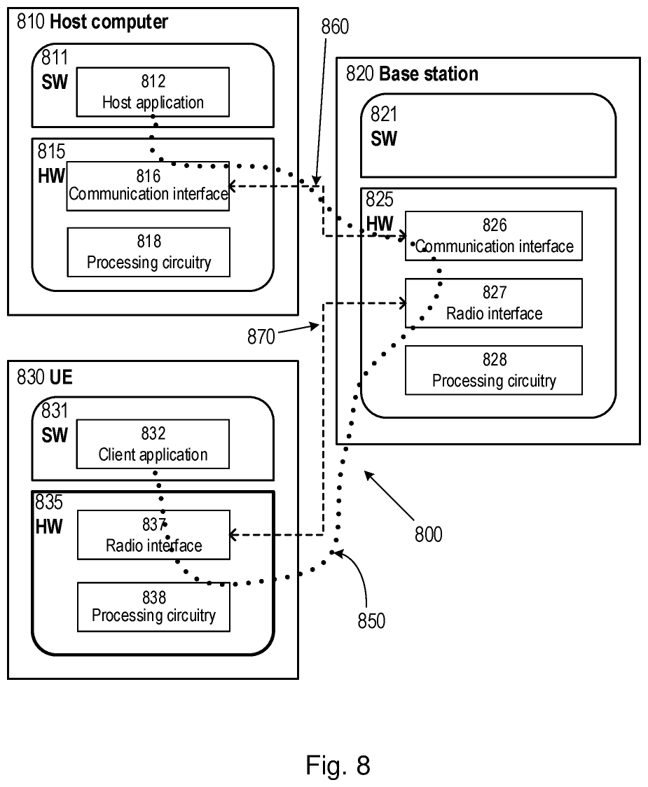

FIG. 8 Illustrates a Host Computer Communicating Via a Base Station with a User Equipment Over a Partially Wireless Connection in Accordance with Some Embodiments.

Example implementations, in accordance with an embodiment, of the UE, base station and host computer discussed in the preceding paragraphs will now be described with reference to FIG. 8. In communication system 800, host computer 810 comprises hardware 815 including communication interface 816 configured to set up and maintain a wired or wireless connection with an interface of a different communication device of communication system 800. Host computer 810 further comprises processing circuitry 818, which may have storage and/or processing capabilities. In particular, processing circuitry 818 may comprise one or more programmable processors, application-specific integrated circuits, field programmable gate arrays or combinations of these (not shown) adapted to execute instructions. Host computer 810 further comprises software 811, which is stored in or accessible by host computer 810 and executable by processing circuitry 818. Software 811 includes host application 812. Host application 812 may be operable to provide a service to a remote user, such as UE 830 connecting via OTT connection 850 terminating at UE 830 and host computer 810. In providing the service to the remote user, host application 812 may provide user data which is transmitted using OTT connection 850.

Communication system 800 further includes base station 820 provided in a telecommunication system and comprising hardware 825 enabling it to communicate with host computer 810 and with UE 830. Hardware 825 may include communication interface 826 for setting up and maintaining a wired or wireless connection with an interface of a different communication device of communication system 800, as well as radio interface 827 for setting up and maintaining at least wireless connection 870 with UE 830 located in a coverage area (not shown in FIG. 8) served by base station 820. Communication interface 826 may be configured to facilitate connection 860 to host computer 810. Connection 860 may be direct or it may pass through a core network (not shown in FIG. 8) of the telecommunication system and/or through one or more intermediate networks outside the telecommunication system. In the embodiment shown, hardware 825 of base station 820 further includes processing circuitry 828, which may comprise one or more programmable processors, application-specific integrated circuits, field programmable gate arrays or combinations of these (not shown) adapted to execute instructions. Base station 820 further has software 821 stored internally or accessible via an external connection.

Communication system 800 further includes UE 830 already referred to. Its hardware 835 may include radio interface 837 configured to set up and maintain wireless connection 870 with a base station serving a coverage area in which UE 830 is currently located. Hardware 835 of UE 830 further includes processing circuitry 838, which may comprise one or more programmable processors, application-specific integrated circuits, field programmable gate arrays or combinations of these (not shown) adapted to execute instructions. UE 830 further comprises software 831, which is stored in or accessible by UE 830 and executable by processing circuitry 838. Software 831 includes client application 832. Client application 832 may be operable to provide a service to a human or non-human user via UE 830, with the support of host computer 810. In host computer 810, an executing host application 812 may communicate with the executing client application 832 via OTT connection 850 terminating at UE 830 and host computer 810. In providing the service to the user, client application 832 may receive request data from host application 812 and provide user data in response to the request data. OTT connection 850 may transfer both the request data and the user data. Client application 832 may interact with the user to generate the user data that it provides.

It is noted that host computer 810, base station 820 and UE 830 illustrated in FIG. 8 may be similar or identical to host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, OTT connection 850 has been drawn abstractly to illustrate the communication between host computer 810 and UE 830 via base station 820, without explicit reference to any intermediary devices and the precise routing of messages via these devices. Network infrastructure may determine the routing, which it may be configured to hide from UE 830 or from the service provider operating host computer 810, or both. While OTT connection 850 is active, the network infrastructure may further take decisions by which it dynamically changes the routing (e.g., on the basis of load balancing consideration or reconfiguration of the network).

Wireless connection 870 between UE 830 and base station 820 is in accordance with the teachings of the embodiments described throughout this disclosure. One or more of the various embodiments improve the performance of OTT services provided to UE 830 using OTT connection 850, in which wireless connection 870 forms the last segment. More precisely, the teachings of these embodiments may improve the quality of service of the relay path and thereby provide benefits such as better responsiveness and quality of experience for a user.

A measurement procedure may be provided for the purpose of monitoring data rate, latency and other factors on which the one or more embodiments improve. There may further be an optional network functionality for reconfiguring OTT connection 850 between host computer 810 and UE 830, in response to variations in the measurement results. The measurement procedure and/or the network functionality for reconfiguring OTT connection 850 may be implemented in software 811 and hardware 815 of host computer 810 or in software 831 and hardware 835 of UE 830, or both. In embodiments, sensors (not shown) may be deployed in or in association with communication devices through which OTT connection 850 passes; the sensors may participate in the measurement procedure by supplying values of the monitored quantities exemplified above, or supplying values of other physical quantities from which software 811, 831 may compute or estimate the monitored quantities. The reconfiguring of OTT connection 850 may include message format, retransmission settings, preferred routing etc.; the reconfiguring need not affect base station 820, and it may be unknown or imperceptible to base station 820. Such procedures and functionalities may be known and practiced in the art. In certain embodiments, measurements may involve proprietary UE signaling facilitating host computer 810′s measurements of throughput, propagation times, latency and the like. The measurements may be implemented in that software 811 and 831 causes messages to be transmitted, in particular empty or ‘dummy’ messages, using OTT connection 850 while it monitors propagation times, errors etc.

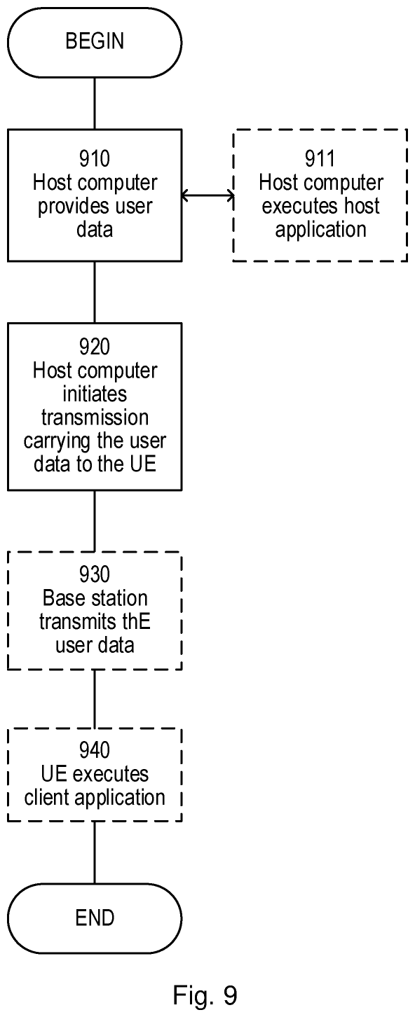

FIG. 9 Illustrates Methods Implemented in a Communication System Including a Host Computer, a Base Station and a User Equipment in Accordance with Some Embodiments.

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

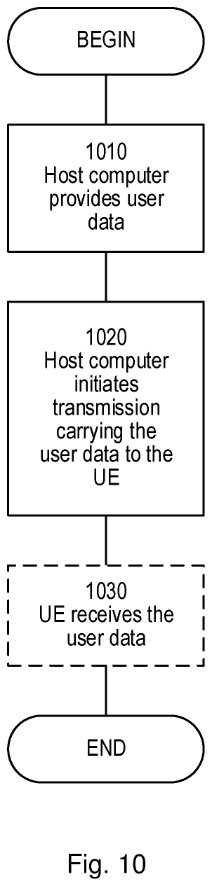

FIG. 10 Illustrates Methods Implemented in a Communication System Including a Host Computer, a Base Station and a User Equipment in Accordance with Some Embodiments

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

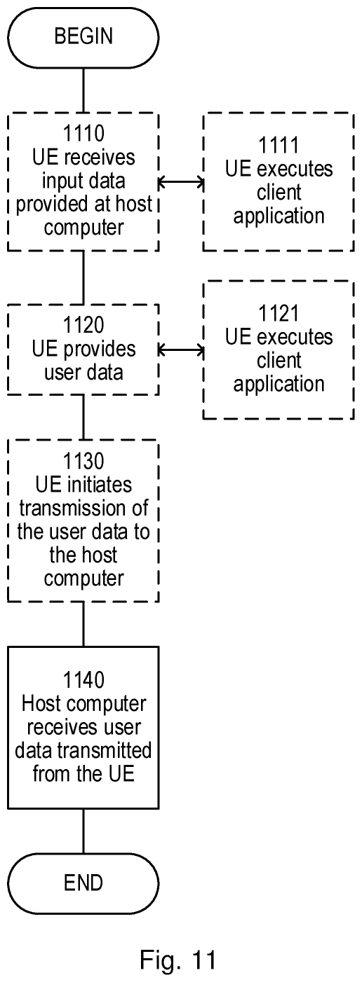

FIG. 11 Illustrates Methods Implemented in a Communication System Including a Host Computer, a Base Station and a User Equipment in Accordance with Some Embodiments.

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

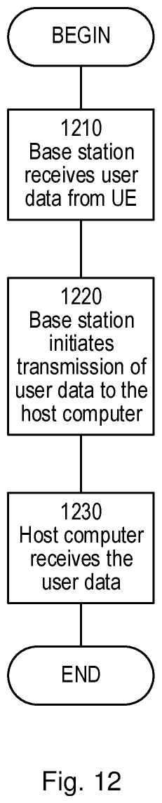

FIG. 12 Illustrates Methods Implemented in a Communication System Including a Host Computer, a Base Station and a User Equipment in Accordance with Some Embodiments.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

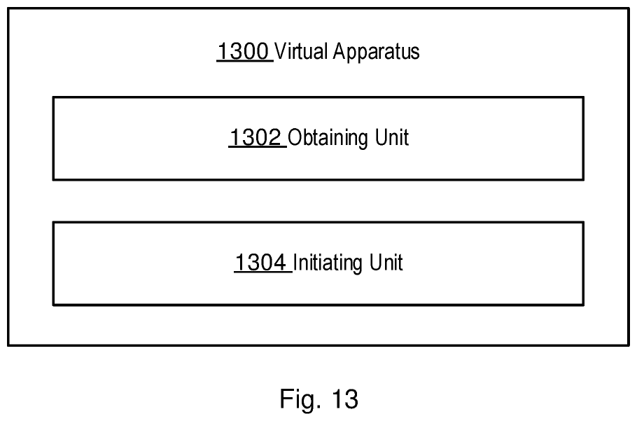

FIG. 13 Illustrates a Virtualization Apparatus in Accordance with Some Embodiments

FIG. 13 illustrates a schematic block diagram of an apparatus 1300 in a wireless network (for example, the wireless network shown in FIG. 4). The apparatus may be implemented in a wireless device or network node (e.g., wireless device 410 or network node 460 shown in FIG. 4). Apparatus 1300 is operable to carry out the example method described with reference to FIG. 3 and possibly any other processes or methods disclosed herein. It is also to be understood that the method of FIG. 3 is not necessarily carried out solely by apparatus 1300. At least some operations of the method can be performed by one or more other entities.

Virtual Apparatus 1300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause obtaining unit 1302, initiating unit 1304, and any other suitable units of apparatus 1300 to perform corresponding functions according one or more embodiments of the present disclosure.

As illustrated in FIG. 13, apparatus 1300 includes obtaining unit 1302 and initiating unit 1304. Obtaining unit 1302 is configured to obtain an indication that a quality of service, QoS, metric is not meeting a QoS requirement, wherein the QoS metric is associated with one of: a traffic flow between the remote device and the destination node, a radio bearer used in communication between the remote device and the destination node; and a logical channel used in communication between the remote device and the destination node. Initiating unit 1304 is configured to responsive to the indication, initiate a recovery action to improve a QoS of the communication between the remote device and the destination node.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### REFERENCES

1. 3GPP TR 23.752 V0.3.0

2. 3GPP TS 23.303 V16.0.0: “Proximity-based services (ProSe); Stage 2”.

3. 3GPP TS 23.287 V16.3.0: “Architecture enhancements for 5G System (5GS) to support Vehicle-to-Everything (V2X) services”.

4. 3GPP TS 36.331 V16.1.1

5. 3GPP TS 36.304 V16.1.0

6. 3GPP TS 36.133 V16.6.0

### Abbreviations

At least some of the following abbreviations may be used in this disclosure. If there is an inconsistency between abbreviations, preference should be given to how it is used above. If listed multiple times below, the first listing should be preferred over any subsequent listing(s).

CA Carrier Aggregation

CBR Channel Busy Ratio

CQI Channel Quality Indicator

CSI Channel State Information

DFN Direct Frame Number

DL Downlink

DRX Discontinuous Reception

FDD Frequency Division Duplex

GNSS Global Navigation Satellite System

HARQ Hybrid automatic repeat request

IE Information Element

MAC Medium Access Control

MIB Master Information Block

NSPS National Security and Public Safety

NW Network

OoC Out-of-Coverage

PDCCH Physical Downlink Control Channel

PDCP Packet Data Convergence Protocol

PDU Protocol Data Unit

PHY Physical (layer)

PL Path Loss

PMI Precoding Matrix Indicator

ProSe Proximity Services

PSCCH Physical Sidelink Control Channel

PSSCH Physical Sidelink Shared Channel

QoS Quality of Service

RL Relay

RLC Radio link control

RM Remote

RI Rank Indicator

RRC Radio Resource Control

RSRP Reference Signal Received Power

RSSI Received Signal Strength Indicator

RX Receive, receiver

SFN System Frame Number

SIB System Information Block

SINR Signal to interference noise ration

SL Sidelink

SLRB Sidelink Radio Bearer

SLSS Sidelink Synchronization Signals

SynchUE Synchronization UE

TDD Time Division Duplex

TETRA Terrestrial Trunked Radio

TX Transmit, transmitter

UE User Equipment

UL Uplink

V2V Vehicle-to-vehicle

V2X Vehicle-to-anything

1x RTT CDMA2000 1x Radio Transmission Technology

3GPP 3rd Generation Partnership Project

5G 5th Generation

ABS Almost Blank Subframe

ARQ Automatic Repeat Request

AWGN Additive White Gaussian Noise

BCCH Broadcast Control Channel

BCH Broadcast Channel

CA Carrier Aggregation

CC Carrier Component

CCCH SDU Common Control Channel SDU

CDMA Code Division Multiplexing Access

CGI Cell Global Identifier

CIR Channel Impulse Response

CP Cyclic Prefix

CPICH Common Pilot Channel

CPICH Ec/No CPICH Received energy per chip divided by the power density in the band

CQI Channel Quality information

C-RNTI Cell RNTI

CSI Channel State Information

DCCH Dedicated Control Channel

DL Downlink

DM Demodulation

DMRS Demodulation Reference Signal

DRX Discontinuous Reception

DTX Discontinuous Transmission

DTCH Dedicated Traffic Channel

DUT Device Under Test

E-CID Enhanced Cell-ID (positioning method)

E-SMLC Evolved-Serving Mobile Location Centre

ECGI Evolved CGI

eNB E-UTRAN NodeB

ePDCCH enhanced Physical Downlink Control Channel

E-SMLC evolved Serving Mobile Location Center

E-UTRA Evolved UTRA

E-UTRAN Evolved UTRAN

FDD Frequency Division Duplex

FFS For Further Study

GERAN GSM EDGE Radio Access Network

gNB Base station in NR

GNSS Global Navigation Satellite System

GSM Global System for Mobile communication

HARQ Hybrid Automatic Repeat Request

HO Handover

HSPA High Speed Packet Access

HRPD High Rate Packet Data

LOS Line of Sight

LPP LTE Positioning Protocol

LTE Long-Term Evolution

MAC Medium Access Control

MBMS Multimedia Broadcast Multicast Services

MBSFN Multimedia Broadcast multicast service Single Frequency Network

MBSFN ABS MBSFN Almost Blank Subframe

MDT Minimization of Drive Tests

MIB Master Information Block

MME Mobility Management Entity

MSC Mobile Switching Center

NPDCCH Narrowband Physical Downlink Control Channel

NR New Radio

OCNG OFDMA Channel Noise Generator

OFDM Orthogonal Frequency Division Multiplexing

OFDMA Orthogonal Frequency Division Multiple Access

OSS Operations Support System

OTDOA Observed Time Difference of Arrival

O&M Operation and Maintenance

PBCH Physical Broadcast Channel

P-CCPCH Primary Common Control Physical Channel

PCell Primary Cell

PCFICH Physical Control Format Indicator Channel

PDCCH Physical Downlink Control Channel

PDP Profile Delay Profile

PDSCH Physical Downlink Shared Channel

PGW Packet Gateway

PHICH Physical Hybrid-ARQ Indicator Channel

PLMN Public Land Mobile Network

PMI Precoder Matrix Indicator

PRACH Physical Random Access Channel

PRS Positioning Reference Signal

PSS Primary Synchronization Signal

PUCCH Physical Uplink Control Channel

PUSCH Physical Uplink Shared Channel

RACH Random Access Channel

QAM Quadrature Amplitude Modulation

RAN Radio Access Network

RAT Radio Access Technology

RLM Radio Link Management

RNC Radio Network Controller

RNTI Radio Network Temporary Identifier

RRC Radio Resource Control

RRM Radio Resource Management

RS Reference Signal

RSCP Received Signal Code Power

RSRP Reference Symbol Received Power OR
Reference Signal Received Power

RSRQ Reference Signal Received Quality OR
Reference Symbol Received Quality

RSSI Received Signal Strength Indicator

RSTD Reference Signal Time Difference

SCH Synchronization Channel

SCell Secondary Cell

SDU Service Data Unit

SFN System Frame Number

SGW Serving Gateway

SI System Information

SIB System Information Block

SNR Signal to Noise Ratio

SON Self Optimized Network

SS Synchronization Signal

SSS Secondary Synchronization Signal

TDD Time Division Duplex

TDOA Time Difference of Arrival

TOA Time of Arrival

TSS Tertiary Synchronization Signal

TTI Transmission Time Interval

UE User Equipment

UL Uplink

UMTS Universal Mobile Telecommunication System

USIM Universal Subscriber Identity Module

UTDOA Uplink Time Difference of Arrival

UTRA Universal Terrestrial Radio Access

UTRAN Universal Terrestrial Radio Access Network

WCDMA Wide CDMA

WLAN Wide Local Area Network

1. A method of providing communication between a remote device and a destination node over a relay path comprising at least one relay device, the method comprising:
obtaining an indication that a quality of service, QoS, metric is not meeting a QoS requirement, wherein the QoS metric is associated with one of: a traffic flow between the remote device and the destination node, a radio bearer used in communication between the remote device and the destination node; and a logical channel used in communication between the remote device and the destination node; and
responsive to the indication, initiating a recovery action to improve a QoS of the communication between the remote device and the destination node.

2. The method of claim 1 wherein the destination node comprises a destination wireless terminal or a base station.

3. The method of claim 1 wherein the QoS metric comprises one or more of:
bit rate, latency, jitter, packet loss, transmission error rate.

4. The method of claim 1 wherein the QoS metric is associated with the traffic flow over the relay path, wherein the relay path comprises a plurality of hops.

5. The method of claim 1 further comprising:
obtaining the QoS metric by summarizing measurement results corresponding to the QoS metric for each hop in the relay path.

6. The method of claim 1 wherein the QoS metric is associated with a particular hop in the relay path, wherein the relay path comprises a plurality of hops.

7. The method of claim 1 wherein the recovery action comprises: performing resource reselection and/or resource pool reconfiguration at the remote device or the relay device.

8. The method of claim 7 wherein, responsive to the remote device or relay device performing resource selection autonomously, the method comprises the remote device or relay device triggering a Random Access Channel, RACH, procedure with a base station to enter RRC_CONNECTED, and
requesting that the base station indicate new radio resources and/or a new resource pool configuration.

9. The method of claim 6 wherein the quality of service metric is associated with a radio bearer used for a particular hop in the relay path, and wherein the recovery action comprises releasing the radio bearer at the particular hop.

10. The method of claim 9 wherein the recovery action further comprises releasing the radio bearer at one or more other hops in the relay path.

11. The method of claim 1 wherein the recovery action comprises:
selecting a new relay device to replace one of the at least one relay devices.

12. The method of claim 1 wherein the recovery action comprises:
selecting a new relay path to replace the relay path.

13. The method of claim 11, wherein the QoS requirement comprises a requirement that a threshold number of traffic flows meet respective quality of service requirements.

14. The method as claimed in claim 1 wherein the method is performed by the remote device.

15. The method as claimed in claim 1 wherein the method is performed by one of the at least one relay device.

16. The method as claimed in claim 1 wherein the step of obtaining comprises one of:
measuring the quality of service, QoS, metric; receiving a measurement result of the quality of service metric from a node in the relay path; and calculating the quality of service metric.

17. The method as claimed in claim 16 wherein the measurement result is received with one or more of:
a wireless device identification associated with the measurement result;
a traffic flow, radio bearer or logical channel identification associated with the measurement result;
a cause of the failure to meet the QoS requirement;
an identification of a hop associated with the measurement results; and
an indication of whether the measurement result is for a traffic flow, radio bearer or a logical channel associated with the relay traffic.

18. A device for providing communication between a remote device and a destination node over a relay path comprising at least one relay device, the device comprising processing circuitry and memory storing computer-readable instructions that, when executed by the processing circuitry cause the processing circuitry to:
obtain an indication that a quality of service, QoS, metric is not meeting a QoS requirement, wherein the QoS metric is associated with one of: a traffic flow between the remote device and the destination node, a radio bearer used in communication between the remote device and the destination node; and a logical channel used in communication between the remote device and the destination node; and
responsive to the indication, initiate a recovery action to improve a QoS of the communication between the remote device and the destination node.

19-35. (canceled)
